(19) United States
(12) Patent Application Publication
(10) Pub. No.: US 2010/0325395 A1
(43) Pub. Date: Dec. 23, 2010

(54) DEPENDENCE PREDICTION IN A MEMORY SYSTEM

(76) Inventors: Doug Burger, Austin, TX (US); Stephen W. Keckler, Austin, TX (US); Robert McDonald, Austin, TX (US); Lakshminarasimhan Sethumadhavan, New York, NY (US); Franziska Roesner, Austin, TX (US)

Correspondence Address: DORSEY & WHITNEY LLP;INTELLECTUAL PROPERTY DEPARTMENT, 250 PARK AVENUE, NEW YORK, NY, 10177, US

(21) Appl. No.: 12/487,804

(22) Filed: Jun. 19, 2009

(51) Int. Cl. G06F 9/30

(52) U.S. Cl. 712/216; 712/E09.016

(57) ABSTRACT

Techniques related to dependence prediction for a memory system are generally described. Various implementations may include a predictor storage storing a value corresponding to at least one prediction type associated with at least one load operation, and a state-machine having multiple states. For example, the state-machine may determine whether to execute the load operation based upon a prediction type associated with each of the states and a corresponding precedent to the load operation for the associated prediction type. The state-machine may further determine the prediction type for a subsequent load operation based on a result of the load operation. The states of the state machine may correspond to prediction types, which may be a conservative prediction type, an aggressive prediction type, or one or more N-store prediction types, for example.

### STATEMENT REGARDING GOVERNMENT SPONSORED RESEARCH

The invention was made with the U.S. Government support, at least in part, by the Defense Advanced Research Projects Agency, Grant number F33615-03-C-4106. Thus, the U.S. Government may have certain rights to the invention.

### BACKGROUND

Load dependence predictors have widely become considered to be an important feature in high-performance microprocessors. In high instruction level parallelism (“ILP”) superscalar cores, exploitable parallelism is curtailed if most load operations cannot issue before earlier store operations with unresolved addresses. Dependence predictors speculate which load operations are safe to issue aggressively, and which load operations must wait for all or a subset of older store operations' addresses to resolve before issuing. Ideal performance may be defined as each load waiting only for the exact stores, if any, that will forward values to the load.

The base assumptions under which previous dependence predictors were shown to be near-ideal have changed. Global wire delays have resulted in the emergence of partitioned architectures, such as modern chip multiprocessors (“CMPs”) and tiled architectures. Distributed architectures that execute single threaded code without a single centralized fetch and/or execution stream will likely make it challenging to deploy predictors which utilize observation of a complete and centralized stream of fetched instructions to synchronize loads with specific stores.

### BRIEF DESCRIPTION OF THE FIGURES

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1A shows an example of computer code illustrating how a given static load may conflict with a different number of stores dynamically and be resolved by a counting dependence predictor implementation;

FIG. 1B is a state diagram illustrating an example of the states of one counting dependence predictor implementation, arranged in accordance with the present disclosure;

FIG. 2 is a diagram showing an example of an implementation of a counting dependence predictor which includes a predictor table and a state machine;

FIG. 3 is a simplified block diagram of an example of a multi-core processing arrangement showing certain message types and stages of an example CDP implementation distributed among different processing cores;

FIG. 4 is a flow diagram illustrating an example of a method according to various implementations of counting dependence predictors;

FIG. 5 is a flow diagram further illustrating an example of a method according to various implementations of counting dependence predictors;

FIGS. 6A, 6B and 6C are simplified topological diagrams showing a high-level floorplan of an integrated circuit with three possible example configurations of a composable lightweight processor, respectively;

FIG. 7 is a schematic diagram of an example of a hardware configuration of a computer system configured for use with an example of a method for counting dependence predictors; and

FIG. 8 is a schematic diagram of an example of a system for performing a method according to various implementations of counting dependence predictors; all arranged in accordance with the present disclosure.

### DETAILED DESCRIPTION

In the following detailed description, reference is made to the accompanying drawings, which form a part hereof. In the drawings, similar symbols typically identify similar components, unless context suggests otherwise. The illustrative examples described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, may be arranged, substituted, combined, separated, and designed in a wide variety of different configurations, all of which are explicitly and implicitly contemplated and made part of this disclosure.

The present application is drawn, inter alia, to methods, apparatus, computer programs and systems related to dependence prediction in a memory system. Memory dependence prediction is a technique used in various modern computer processors to execute load instructions as early as possible. Memory dependence prediction may use various models to speculate whether or not a particular load instruction is dependent on an earlier, unissued store operation instruction which may alter the contents of the memory location in question. Thus, memory dependence predictors may speculate which load operations are safe to issue aggressively, and which load operations should wait for all or a subset of other store operations' addresses to resolve before issuing.

Memory dependence prediction may be a feature in high-performance microprocessors. In high-ILP superscalar cores, exploitable parallelism generally is curtailed if most load operations cannot issue before earlier store operations with unresolved addresses.

A counting dependence predictor (“CDP”) may be referred to as a memory dependence predictor that may categorize load instructions as a plurality of conditional states, such as either aggressive, conservative or N-store loads, for example. As used herein, the term N-store load refers to some number (N) of matching stores that precede a load operation. CDPs may be designed to work well in distributed architectures (e.g., micro-architectures with multiple processing cores), in which a centralized fetch streamed access to some global execution information may be infeasible. CDPs may also be designed to be used in monolithic architectures (e.g., architectures based on a single processing core). Implementations of CDPs may be designed to make as accurate predictions as possible with as little information as possible that is not local to the predictor. Any needed information may be available, or easily made available, locally to the predictor. One particular feature in various implementations of CDPs, for example, may be that the prediction mechanism may be autonomous of the fetch stream and predict the local events for which a particular dynamic load operation should wait. These events may include, for example, some number (N) of matching stores, and may be tracked without complete global execution information.

Various implementations of CDPs may predict the events for which a particular dynamic load operation should wait. These events may include some number of various matching stores rather than specific stores identified before execution, for example. Nevertheless, various implementations of CDPs may predict how many “in-flight” store operations a load will conflict with utilizing a possible CDP implementation that predicts loads to wait for zero, one, or more store matches, for example. An “in-flight” store operation is a store operation that has been fetched and decoded but has not yet been completed. Thus, it may be possible to predict when it is safe to execute a given load by predicting how many store matches for which that load should wait, for example. Various implementations of CDPs may be arranged to wait for a learned number of stores to complete before waking a load predicted to be dependent thereon. Various implementations of CDPs may predict dynamic loads to be dependent based, at least in part, on a predicted number of arbitrary stores, as opposed to other dependence predictors that may predict dynamic loads to be dependent based on one or more specific dynamic stores.

The figures include numbering to designate illustrative components of examples shown within the drawings, including the following: A computer system 100; an example code 104; a Store A 106; a Store B 108; a Load C 110; a value i 112; example cases 120, 130, 140; ordering possibilities 122, 132, 142; an Aggressive state 152; a Conservative state 154; a N-store state 156; a processing arrangement 200; CDP 202; a predictor storage 204; a hashing function 206; a load 208; a storage entry 210; a value 211; a state machine 212; state machine state “00” (“aggressive”) 214; state machine state “11” (“conservative”) 216; state machine state “01” (“one-store”) 218; state machine state “10” (“one-store”) 220; pipeline is not flushed 222; a pipeline flush 224; transition 226, transition 228, transition 230, transition 232, transition 234, transition 236, an 8-core composed processor 300; an on-chip network 305; a load 310; processing “core 5” 312; load routing operation 313; processing “core 6” 314; prediction operation 315; processing “core 1” 316; processing “core 2” 318; a store completion message 320; an all-previous-stores-completed message 322; a block owner M 324; a block M326; a registration message 328; a wakeup message 330; a composable lightweight processor 400; a method 402; operation 410 (apply a hash function to a program counter of a load); operation 412, (index a predictor table); operation 414 (inquire whether the current state of the state machine is 00 (aggressive)); operation 416 (put the load in a load buffer and tag it with bits indicating that the load has “issued”); operation 418 (execute the load instruction); operation 420 (terminate process); operation 422 (inquire if the state is 01 (one-store) or 10 (one-store)); operation 424 (put the load in the load buffer and tag it with bits indicating “wait for 1-store”); operation 426 (inquire whether the state is 11 (conservative)); operation 428 (put the load in load buffer and tag it with bits indicating “wait for all previous stores”); a composable lightweight processor 500; operation 510 (search for a waiting load to the same address that is more recent (or younger) in program order than a store in flight); operation 512 (inquire whether there are any more matching loads); operation 513 (inquire whether there are other stores younger than the arriving store, but older than the load to the same address); operation 514 (inquire whether a matching load is marked as “issued”); operation 516 (update the predictor table entry for the load to state “11” (conservative)); operation 518 (flush the pipeline); operation 520 (inquire whether a matching load is marked as “wait for 1-store”); operation 526 (mark load as “issued” in the load table); operation 528 (inquire whether the predictor table entry for the waiting load is in state “01”); operation 530 (change the state to “10”); operation 532 (execute the load instruction) operation 534 (matching load is marked as “wait for all previous stores”); operation 552 (inquire if there is a waiting load for which all older in-flight stores have issued); operation 554 (inquire if a predictor table entry for a load is in state “01”); operation 556 (update the state to “00”); operation 558 (execute the load); operation 560 (inquire whether the predictor table entry for a load is in state “10”); operation 562 (update the state to “01”); operation 564 (the predictor table entry for a load is in state “11”); operation 566 (inquire if there are 0 or 1 store matches for a load); operation 568 (update the state to “10”); operation 570 (terminate process); possible configurations of a composable lightweight processor (CLP) 601, 602, 603; a single processing core 610; composed processors 620, 640, 650, 660, 680; banked L2 cache 630, 670, 690; a computer system 700; a processor 701; a system bus 702; an operating system 703; an application 704; read-only memory (“ROM”) 705; random access memory (“RAM”) 706; a disk adapter 707; a disk unit 708; a communications adapter 709; a user interface adapter 710; a display adapter 711; a keyboard 712; a mouse 713; a speaker 714; a display monitor 715; processing cores 720; banked L2 caches 721; example of counting dependence predictor (“CDP”) 724; computer system 800; processing arrangement 805; block 810 (associate one of a plurality of prediction types to a load operation from the memory); block 820 (evaluate whether any precedents for the associated prediction type have been satisfied); and block 830 (execute the load operation if the precedents for the associated prediction type have been satisfied).

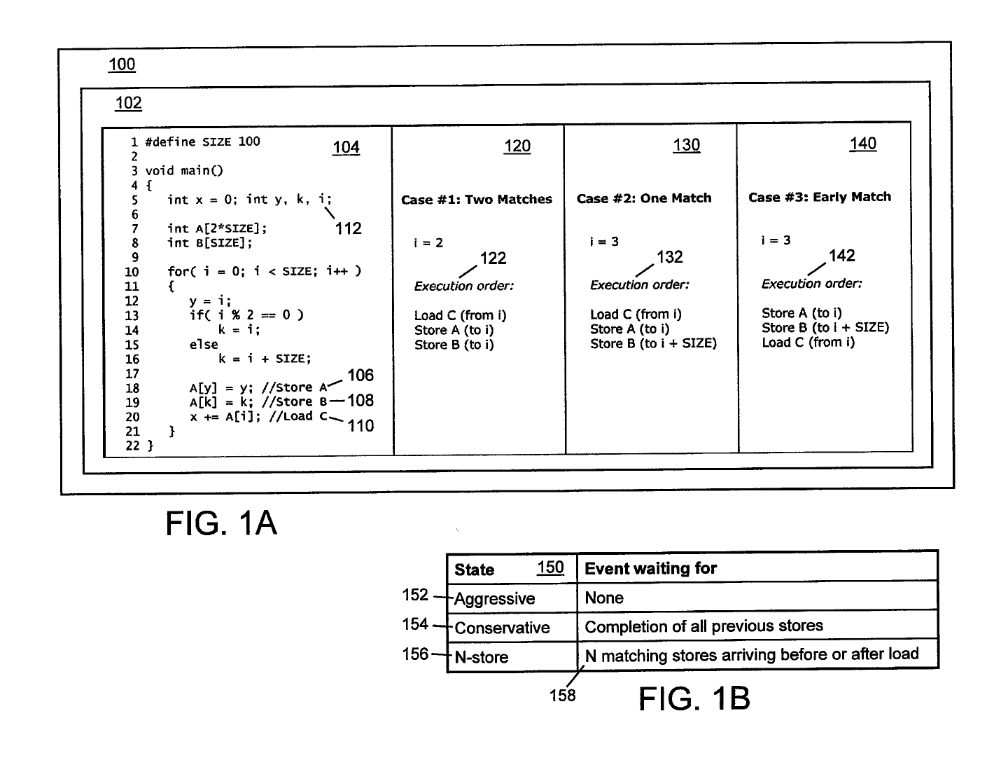

FIG. 1A shows an example of computer code illustrating how a given static load may conflict with a different number of stores dynamically and be resolved by a counting dependence predictor implementation, arranged in accordance with the present disclosure. As depicted, computer system 100 includes example code 104, a Store A 106, a Store B 108, a Load C 110, a value i 112, example cases 120,130,140 and ordering possibilities 122,132,142. In the example code 104 shown in FIG. 1A, Load C 110 may follow Store A 106 and Store B 108 in program order. Load C 110 may be dependent on Store A 106, but whether it is also dependent on Store B 108 depends on the value of i 112 in this example. The three example cases 120, 130 and 140 illustrated in FIG. 1A show different ordering possibilities 122, 132 and 142 during the execution of the code 104.

A load violation may occur when a load executes before an older store to the same address. When such a violation is detected, the processors may remediate the violation, such as by throwing away all of the instructions that received the incorrect data (via a pipeline flush) and restarting execution from the point of the load operation that resulted in the load violation. An out-of-order pipeline may be used to improve the performance of data processing systems through performing loading of instructions or data, core execution, and other functions performed by a core simultaneously, rather than having load operations delay the operation of the core. Flushing the pipeline may include detecting the triggering misprediction, flushing the bad state, and reinitiating dispatch, as well as refilling the pipeline.

FIG. 1B is a state diagram illustrating an example of the states of one counting dependence predictor implementation, arranged in accordance with the present disclosure. Example states 150 may include one or more of Aggressive 152, Conservative 154, and/or N-store 156 in some possible CDPs. A CDP may be designed to handle some or all of the example cases 120, 130 and 140 and transition among them.

When a CDP predicts that a load is dependent on a store and that store has not executed, the load may be suspended. The load may be subsequently invoked (or woken, called, initiated, activated, etc.) by some triggering event, as defined by the CDP, for example. Various information, such as, e.g., the control path, the owner core to which a block is assigned based on its starting address (“PC”) or the load's address, may be used to predict which event should cause a load to issue. The terms “matching load” and “matching store” refer to load or store operations wherein the load's address overlaps at least part of the store's address, or vice versa. It will be appreciated that matches to part of the address can occur because loads and stores may operate with different sized pieces of data. In a distributed architecture, this information may be locally available or globally broadcast for other purposes. CDPs may aim to use as little additional remote messaging as possible to predict the type of event that may cause a load to be woken, for example.

The states of one example of a CDP are shown outlined in FIG. 1B. Different prediction types may be defined by the event type that triggers the load wakeup. For example, prediction types may include aggressive load 152, conservative load 154 and N-store load 156 types. Referring to FIG. 1B, these prediction types may be understood as:
1. An aggressive load 152 may execute speculatively as soon as its address is available;
2. A conservative load 154 may wait until all previous stores (in program order) have completed; and/or
3. An N-store load 156 may wait for a learned number of arbitrary matching older stores. In the example described here, a load (e.g., 110) predicted in this third category will wait on any one store match (e.g., N equals one). Because the load's address should be resolved before store matches may be counted in this example, the load may issue to memory and wait at the data cache for its wakeup event.

A “store-match” event may be an event that may happen when a store to the same address resolves after a waiting load. The particular store on which a load is dependent may resolve before the load instead, however. Therefore, implementations of CDPs may use a process that may be called, for example, “already arrived stores”, in which loads that are predicted to be dependent on one store are woken immediately, or sometime sooner than they would otherwise, if a matching store still in flight has already been resolved, for example. By waking one-store loads based on the presence of an already issued older store that is predicted to likely be the load's only store match, the number of cases in which a load may be incorrectly predicted one-store and needlessly waits for more and/or all older stores to complete may be reduced. Thus, an N-store case (where N is an integer 1 or greater) is one that prevents the load from issuing until N program-earlier stores with matching addresses have taken place. By considering early arriving stores, one-store loads may be woken and the dependence predictor may be trained on store-to-load forwardings, for example.

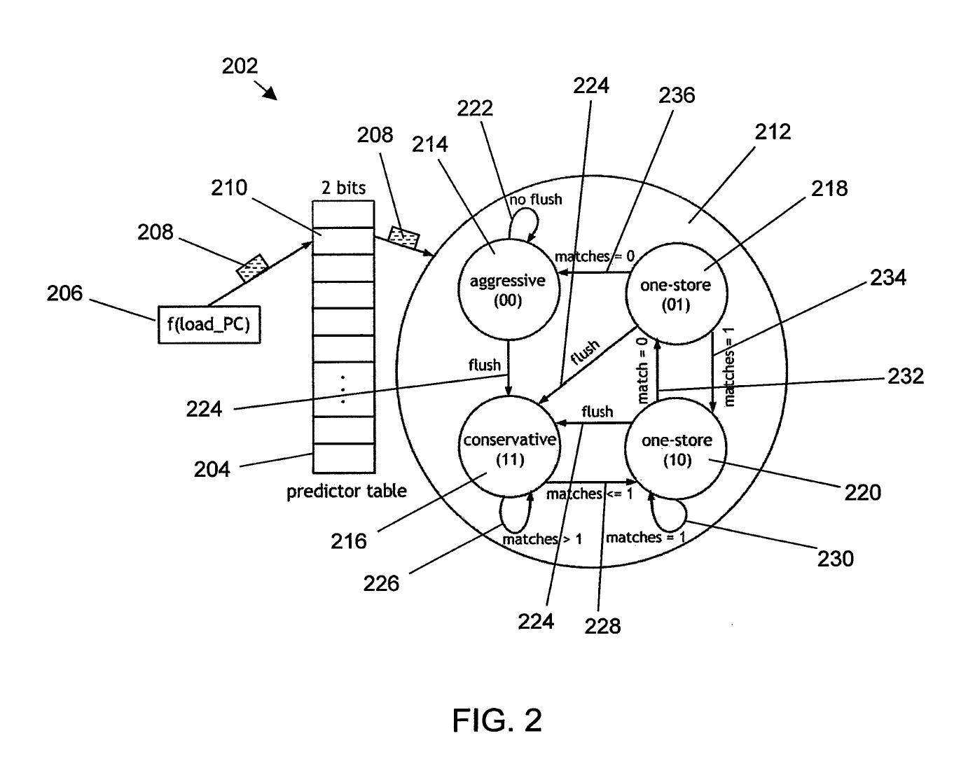

FIG. 2 is a diagram showing an example of an implementation of a counting dependence predictor which includes a predictor table and a state machine, arranged in accordance with the present disclosure. An example implementation of a CDP 202 may utilize a processing arrangement 200 and may include one or more of a predictor storage 204, a hashing function 206, a load 208, a storage entry 210, a value 211, a state machine 212, state machine state “00” (“aggressive”) 214, state machine state “11” (“conservative”) 216, state machine state “01” (“one-store”) 218, state machine state “10” (“one-store”) 220, pipeline is not flushed 222, and/or a pipeline flush 224. Predictor storage 204 may be a table indexed using known methods, such as a hashing function 206 of the program counter (the address of the load that is consulting the predictor).

In this example, each storage table entry 210 in the predictor storage table 204 is a 2-bit value 211, which may encode one of four states 214, 216, 218 and 220 in a state machine 212 specific to the load(s) 208 that hash to that storage table entry 210. The states 214, 216, 218 and 220 may indicate a measure of confidence in whether the load 208 is independent of prior stores. In FIG. 2, for example, in state “00” (aggressive) 214, CDP 202 may treat the load 208 as being independent of prior stores and execute the load 208 immediately. Further in this example, in state “11” (conservative) 216, CDP 202 may treat the load 208 as being dependent on prior stores and should wait for all prior stores to complete before executing the load 208. In states “01” (one-store) 218 and “10” (one-store) 220, both of which are in between aggressive and conservative, CDP 202 may wait for one store to the same address to complete before executing the load 208, for example.

In this example, when CDP 202 is reset, all of the storage table entries 210 may be set to state “00” (aggressive) 214. The state machine 212 may transition as loads 208 and stores resolve, for example. In this example, if a load 208 arrives and its state machine 212 is in state “00” (aggressive) 214, load 208 may execute immediately. If the speculation turns out to be correct and so the load 208 will not result in the pipeline being flushed 222 due to a store/load ordering violation, state machine 212 may stay in state “00” (aggressive) 214. But if the speculation turns out to be incorrect and load 208 is flushed, then state machine 212 may transition to state “11” (conservative) 216. When a load 208 arrives and finds state machine 212 in “11” (conservative) 216, the state machine 212 may wait until all prior stores complete before executing load 208. If two or more stores to the same address complete while load 208 is waiting, then state machine 212 may remain in state “11” (conservative) 216 for that particular load 208 as indicated by state transition 226. If one or fewer matching stores to the same address complete while load 208 is waiting, then state machine 212 may transition 228 to state “10” (one-store) 220.

In this example, a load 208 that arrives and finds state machine 212 in state “10” (one-store) 220 may wait for one matching store to complete before issuing. If one matching store completes, state machine 212 may stay in state “10” (one-store) 220, as indicated by state transition 230. If no matching stores complete while load 208 is waiting, state machine 212 may transition 232 to state “01” (one-store) 218. A load 208 that arrives and finds state machine 212 in state “01” (one-store) 218 may also wait for one matching store to complete before issuing in this example. If one matching store that is older than load 208 in program order completes, state machine 212 may transition 234 to state “10” (one-store) 220. If no matching stores complete while load 208 is waiting, state machine 212 may transition 236 to state “00” (aggressive). Thus, in this example, states “01” (one-store) 218 and “10” (one-store) 220 are labeled “one-store” indicating that a load 208 may wait for one matching store to arrive prior to executing. In this example, state “01” (one-store) 218 may be slightly more aggressive than state “10” (one-store) 220 as a given load 208 in state “10” (one-store) 220 may have to execute twice with no prior matching stores before reaching state “00” (aggressive) 214. In the cases described in this example, regardless of the current state of the state machine, a pipeline flush 224 due to a store/load ordering violation may cause state machine 212 to transition to state “11” (conservative) 216.

If the predictor storage table 204 is not large enough to accommodate all possible loads, multiple loads 208 may hash to the same predictor storage table entry 210 and employ the same state machine 212, but there may be interference among the multiple loads 208. Thus, while in the examples described above a two-bit (four states 214, 216, 218 and 220) state machine 212 is utilized, various implementations of CDP may use state machines 212 with more than four states, for example. The examples described above also utilize a monolithic CDP 202 with a single centralized predictor storage table 204. However, various implementations of CDP may be partitioned for use in a distributed processor, with a subset of the table at each partition.

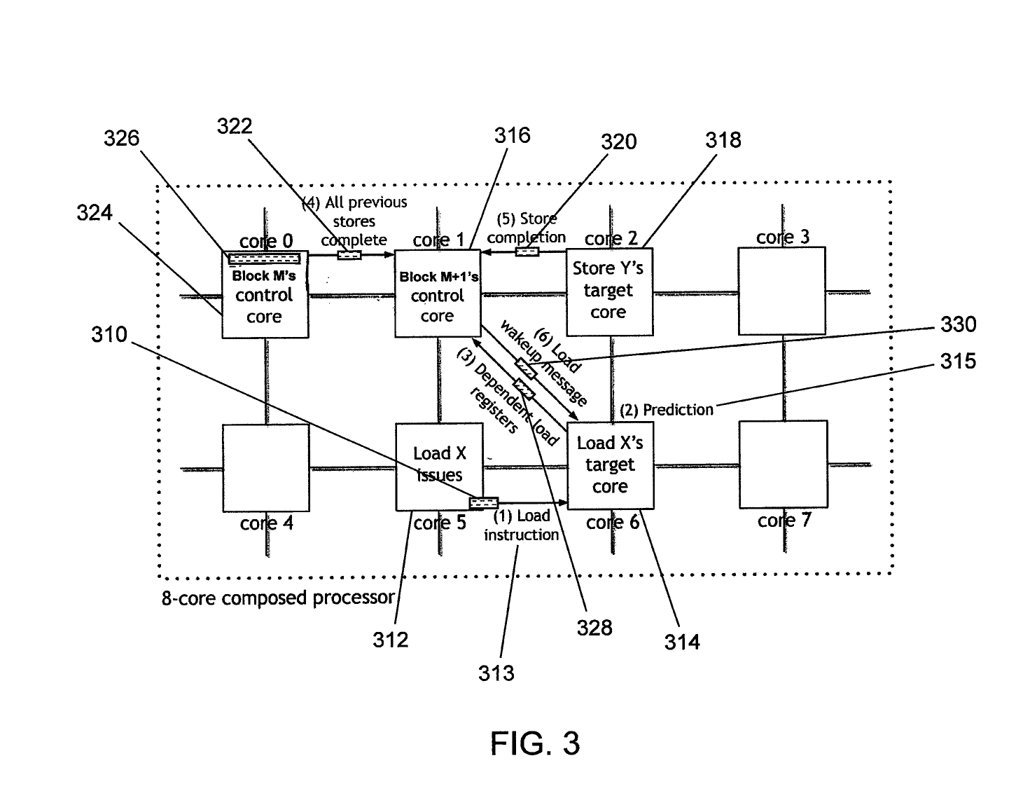

FIG. 3 is a simplified block diagram of an example of a multi-core processing arrangement showing certain message types and stages of an example CDP implementation distributed among different processing cores, arranged in accordance with the present disclosure. An 8-core composed processor 300 may include one or more of an on-chip network 305, a load 310, a processing “core 5” 312, load routing operation 313, processing “core 6” 314, prediction operation 315, processing “core 1” 316, processing “core 2” 318, a store completion message 320, an all-stores-completed message 322, a block owner M 324, a block M 326, a registration message 328 and/or a wakeup message 330.

The example CDP implementation illustrated in FIG. 3 may use four message types, as described below. Of course, it will be appreciated that other protocols may be implemented with more, less or different message types. The prediction and wakeup of a load operation may be handled by various CDP implementations, as described in various examples below. Each operation may occur on any core, or, in some cases, on the same core.

For example, on the 8-core composed processor 300; load 310 may be issued at one core (e.g., “core 5” 312, in this example), and may be routed (operation 313) to the core containing the appropriate cache bank, determined by the address of the load. Prediction (operation 315) may occur at the core containing that cache bank (e.g., “core 6” 314, in this example). If load 310 is predicted aggressive, it may be executed immediately. If load 310 is predicted to be dependent (either conservative or waiting on some events), a registration message 328 may be sent to the controller core, the block owner of the load's block (e.g., “core 1” 316, in this example). The registration message 328 may be a request to the block owner 316 to inform the load 310 when all or N (e.g., number of matching stores that proceed a load operation) of the necessary older stores have completed, for example.

To enable the block's controller core 316 to know when all or N stores prior to a load have completed, and therefore respond to a registration message 328, two additional types of messages may be provided, for example. First, whenever a store in the block completes, a store completion message 320 may be sent from the store's target core (e.g., “core 2” 318, in this example) back to the block's controller core 316. Because store completion messages 320 may already be utilized for determining block completion, it may not be necessary to add such store completion messages 320 specifically for the purpose of dependence prediction.

Before a registered load 310 may be safely initiated, the controller core 316 may need to know that all or N of the stores older than load 310 have completed. It may not be sufficient to know that all older stores in the load's block have completed since there may be pending stores in older blocks. Thus, an all-stores-completed message 322 may be utilized, which block owner M 324 may send to block owner M+1 316 as soon as all or N of the stores in block M 326 have completed. This single all-stores-completed message 322 that may be sent between controller cores of successive blocks may prevent the need to broadcast store completion messages to every core, for example.

Controller core 316 may be responsible for sending wakeup messages 330 to any load 310 that has registered with it (e.g., any load 310 which was not predicted aggressive). After all stores older than a registered load 310 have completed, controller core 316 may send a wakeup message 330 back to the core containing the cache bank at which the load 310 is waiting (e.g., “core 6” 314), for example. When a waiting load 310 receives a wakeup message 330, it may be free to execute. The wakeup message 330 may be utilized for loads 310 that are predicted conservative and loads 310 that are incorrectly predicted N-store (e.g., those loads 310 which effectively execute conservatively because no store match ever occurs). Because a memory instruction's cache bank may be determined by its address, matching stores should arrive at the core where the load is waiting. Thus, if there were N matches for an N-store load, that load may already have been initiated when the wakeup message 330 arrives. In this example, the wakeup message 330 may safely be ignored. In a 1-store example, if two matching stores arrive, if the second arrived store is later in program order than the first arrived store, but prior to a later dependent load 310 having issued, the first store may initiate the load 310 and the second may trigger a violation flush because the load would have received the wrong value, for example.

In some examples, one all-stores-completed message 322 may be sent per 128-instruction block, and two messages (registration 328 and wakeup 330) may be sent for each load 310 predicted to be dependent on unarrived older stores. Loads correctly predicted independent may require no messages at all, for example. Message latencies may have little affect on overall performance since most such latencies may be hidden by execution, for example. An example of when message latency may lead to performance loss is when a load on the critical path is predicted conservative and waits for the wakeup message before knowing that all older stores have completed. In some examples, the predictor may be located in a common place where loads and stores to the same address meet, and thus may be arranged for operation with either centralized fetch and execute architectures or distributed fetch and execute architectures. For example, the example distributed protocol described above may be utilized to implement dependence prediction on the memory side (e.g., at partitioned and/or distributed cache banks) of a distributed architecture system, after a load has been issued and sent to the core containing its cache bank.

If the predictor is located at the site where the load or store addresses are computed, that is referred to as “execution side.” If the predictor is located at the site where the cache storage for the computed address is located, that is referred to as “memory side.” In some examples, loads may be indexed into the predictor table at that core. Alternatively, in various implementations of a CDP, prediction may occur on the execution side, before the load issues. For example, an advantage of placing prediction occurrence on the execution side may be that the prediction table may be indexed by the load's PC, rather than a combination of the PC and address. However, execution-side prediction may require a more complex protocol with additional messaging.

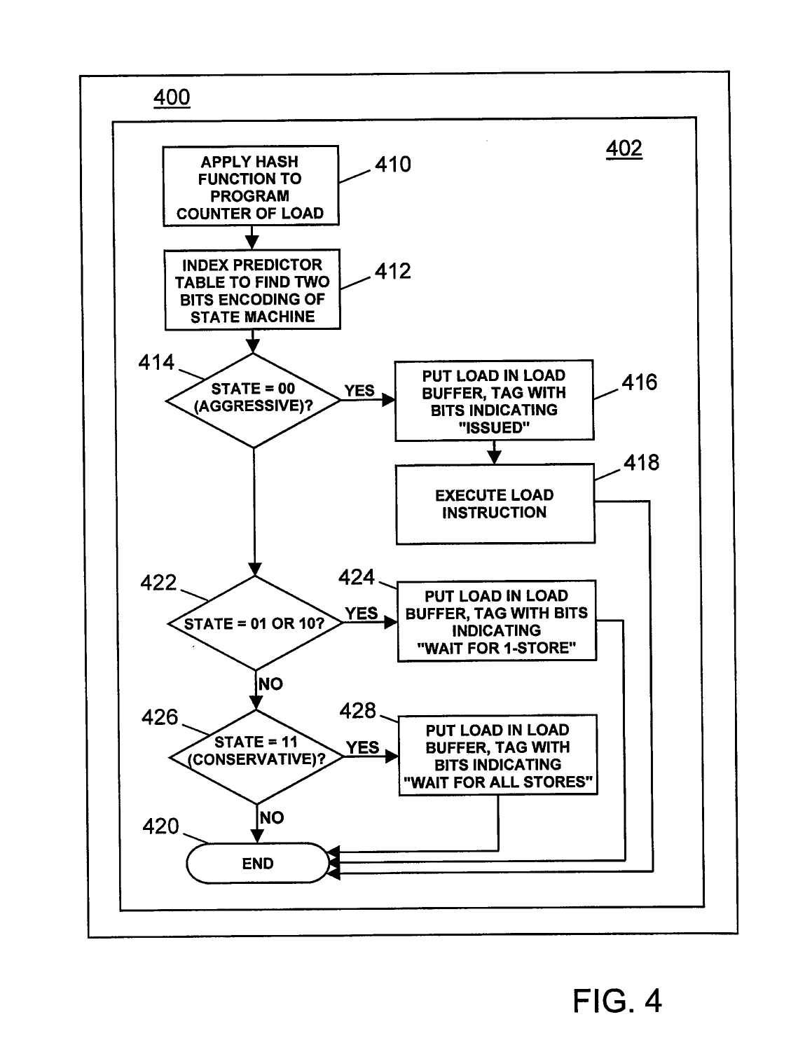

FIG. 4 is a flow diagram illustrating an example of a method according to various implementations of counting dependence predictors, arranged in accordance with the present disclosure. Method 402 may be executed by a composable lightweight processor 400, such as is described herein, for example. The described method 402 may include one or more of operations 410, 412, 414, 416, 418, 420, 422, 424, 426, and/or 428.

In operation 410, the example method 402 may include applying a hash function to a program counter of a load. In operation 412, the method may include indexing a predictor table to facilitate two-bit encoding of a state machine. In operation 414, the example method may include inquiring whether the current state of the state machine is 00 (aggressive). If the state is 00 (aggressive), then, in operation 416, the example method may put the load in a load buffer and tag it with bits indicating that the load has “issued.” In operation 418, the process may further include executing the load instruction, after which the method may terminate in operation 420. If, in operation 414, the example method determines that the current state is not 00 (aggressive), then the example method may include in operation 422 inquiring if the state is 01 (one-store) or 10 (one-store). If the state is 01 (one-store) or 10 (one-store), then, in operation 424, the example method may include putting the load in the load buffer and tagging it with bits indicating “wait for 1-store”, after which the example method may terminate in operation 420. If, in operation 422, it is determined that the state is not 01 (one-store) or 10 (one-store), then, in operation 426, the process may advance to inquiring whether the state is 11 (conservative). If the state is 11 (conservative), the example method may include putting the load in load buffer and tag with bits indicating “wait for all stores,” after which the example method may terminate in operation 420.

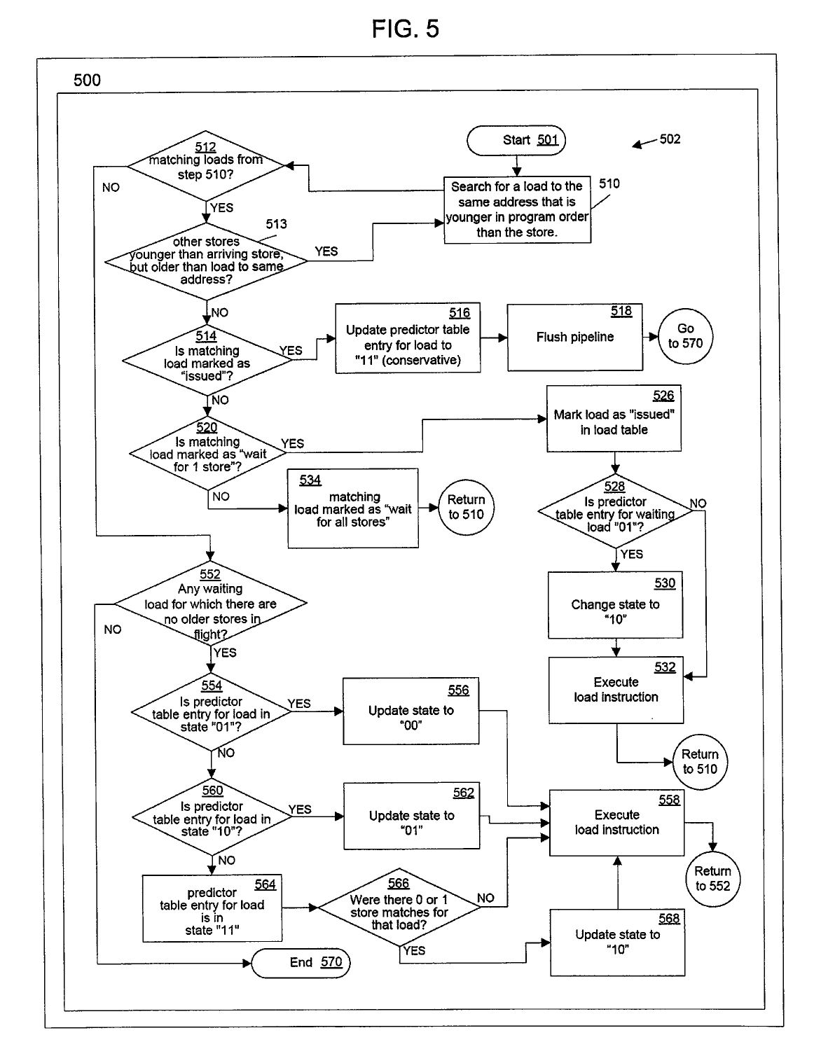

FIG. 5 is a flow diagram further illustrating an example of a method according to various implementations of counting dependence predictors, arranged in accordance with the present disclosure. The illustrated method 502 may be executed by a composable lightweight processor 500 and may include one or more operations, including operation 501 (start), operation 510 (search for a load to the same address that is more recent (or younger) in program order than a store in flight), operation 512 (inquire whether there are any matching loads), operation 513 (inquire whether there are other stores younger than the arriving store, but older than the load to the same address), operation 514 (inquire whether a matching load is marked as “issued”), operation 516 (update the predictor table entry for the load to state “11” (conservative)), operation 518 (flush the pipeline), operation 520 (inquire whether a matching load is marked as “wait for 1-store”), operation 528 (inquire whether the predictor table entry for the waiting load is in state “01”), operation 530 (change the state to “10”), operation 532 (execute the load instruction) operation 534 (matching load is marked as “wait for all stores”),), operation 552 (inquire if there is a waiting load for which there are no older non-executed stores in flight), operation 554 (inquire if a predictor table entry for a load is in state “01”), operation 556 (update the state to “00”), operation 558 (execute the load), operation 560 (inquire whether the predictor table entry for a load is in state “10”), operation 562 (update the state to “01”), operation 564 (the predictor table entry for a load is in state “11”), operation 566 (inquire if there are 0 or 1 store matches for a load), operation 568 (update the state to “10”), and/or operation 570 (terminate process).

In operation 510, the method 502 may search for a load to the same address that is more recent (or younger) in program order than a store in flight. In operation 512, the method makes a determination whether the condition in step 510 has been satisfied. If the condition in 510 has been satisfied, in operation 513 the method determines whether there are other stores younger than the arriving store, but older than the load to the same address. If there are stores that satisfy the condition of operation 513, the method may return to operation 510. Otherwise, the method may proceed to operation 514.

In operation 514, the process may include inquiring whether a matching load is marked as “issued.” If a matching load is marked as “issued,” then, in operation 516, the process may include updating the predictor table entry for the load to state “11” (conservative), after which the method may include flushing the pipeline in operation 518 before returning to operation 510, which may include searching for a waiting load to the same address that is more recent in program order than the store. It in operation 514, the example method determines that a matching load is not marked as “issued,” then the process may advance to operation 520, and inquire whether a matching load is marked as “wait for 1-store”. If a matching store is marked as “wait for 1-store”, then, in operation 526, the method may include marking the load as “issued” in the load table and, in operation 528, inquiring whether the predictor table entry for the waiting load is in state “01”. If the waiting load is in state “01”, then, in operation 530, the example method may include changing the state to “10”, and then, in operation 532, executing the load instruction before returning to operation 510, in which the example method may include searching for a waiting load to the same address that is younger in program order than the store. If, in operation 528, the example method determines that the predictor table entry for the waiting load is not in state “01”, then, the example method may proceed to operation 532, and execute the load instructions before returning to operation 510.

If, in operation 520, the method 502 determines that a matching store is not marked as “wait for 1-store”, then the process may advance to operation 534, a matching load may be marked as “wait for all stores” and the method may return to operation 510.

If, in operation 512, the method 502 determines that there are no matching loads from step 510, then, in operation 552, the method may determine whether there is a load for which there are no older non-executed stores in flight. Although operation 552 is illustrated in FIG. 5 as operating sequentially after operation 510, it is also possible for operation 552 to operate as a parallel operation with operation 510. If there are no loads that satisfy the condition of operation 552, then the example method may proceed to operation 570 and terminate. If there are more loads that satisfy the condition in operation 552, then the example method may advance to operation 554, and inquire if a predictor table entry for a load is in state “01”. If a predictor table entry for a load is in state “01”, then in this example, operation 556 may include updating the state to “00” and then executing the load in operation 558 before returning to operation 552, in which the example method 502 may include searching for a waiting load for which the are no older stores.

If, in operation 554, the method 502 may determine that a predictor table entry for a load is in state “01”, then, in operation 560, the method 502 may include inquiring whether the predictor table entry for a load is in state “10”. If the predictor table entry for a load is in state “10”, then the method 502, in operation 562, may include updating the state to “01” and then executing the load in operation 558 before returning to operation 550. If, in operation 560, the method 502 determines that the predictor table entry for a load is not in state “10”, then the method 502 may advance to operation 564, and determine whether the predictor table entry for a load is in state “11”. If the predictor table entry for a load is not in state “11”, the method 502 may proceed to operation 570 to terminate. If the predictor table entry for a load is in state “11”, the method 502, in operation 566, may include inquiring if there are 0 or 1 store matches for a load. If there are 0 or 1 store matches for a load, then, in operation 568, the method 502 may update the state to “10” and then execute the load instruction in operation 558 before returning to operation 550. If there are no 0 or 1 store matches for a load, then the example method 502 may include executing the load instruction in operation 558 before returning to operation 550.

Examples provided herein may be used to work effectively in a distributed micro-architecture, where centralized fetch and execution streams may be infeasible or undesirable, as well as in a uniprocessor micro-architecture. Various examples also may be used in monolithic architectures. In various examples, a method according to the present application may run continually. Continually may include running at regular intervals, or when predetermined processes occur. In various examples, hardware and software systems and methods are disclosed. There are various vehicles by which processes and/or systems and/or other technologies described herein may be affected (e.g., hardware, software, and/or firmware); and a vehicle used in any given implementation may vary within the context in which the processes and/or systems and/or other technologies are deployed, for example.

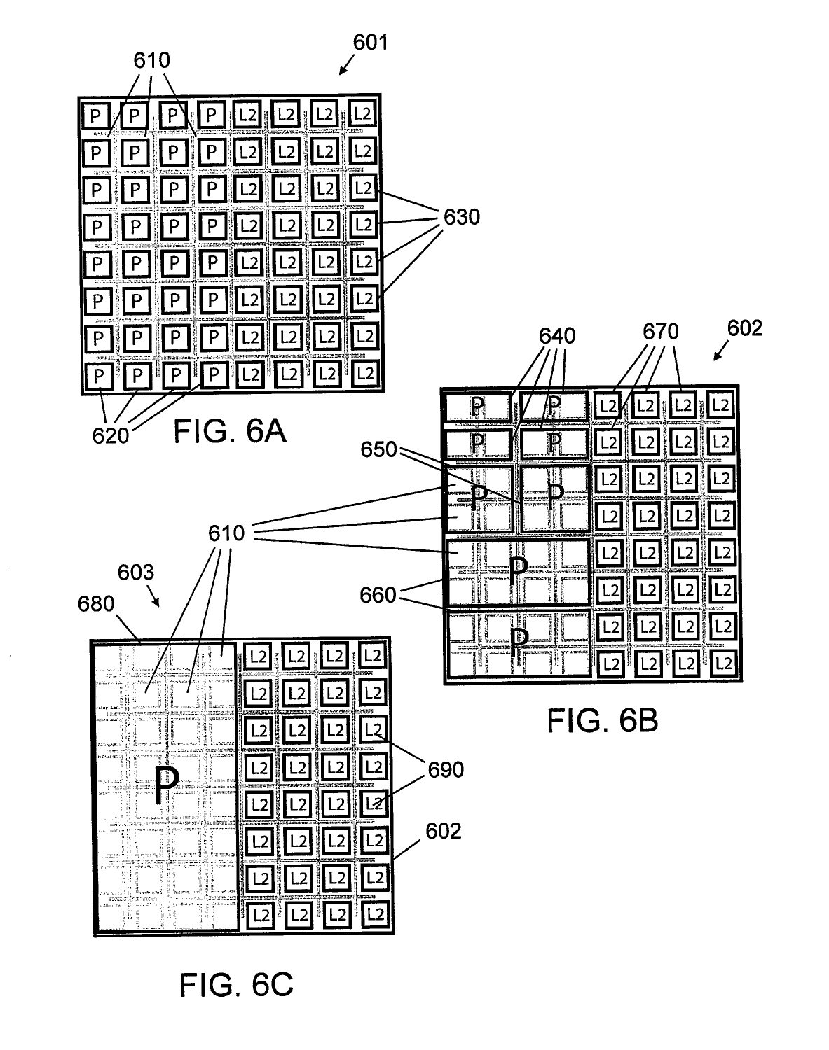

FIGS. 6A, 6B and 6C are simplified topological diagrams showing a high-level floorplan of an integrated circuit with three possible example configurations of a composable lightweight processor, respectively, arranged in accordance with the present disclosure. The three possible configurations 601,602 and 603 may include at least one single processing core 610, composed processors 620, 640, 650, 660 and 680, and banked L2 cache 630,670 and 690. The squares located on the left of each floorplan and which are denoted by a P, represent a single processing core 610 while the squares on the right half (630,670 and 690) and designated L2 represent a banked L2 cache. As shown for example, if a large number of threads are available, an example system may run 32 threads, one on each composed processor 620 corresponding to each of the 32 processing cores 610 (e.g., FIG. 6A). Other examples may run more or less than 32 threads depending on, e.g., the number of processing cores. If high single thread performance is required and the thread has sufficient ILP, the CLP may be configured to use an optimal number of processing cores 610 that improves performance. To optimize for energy efficiency, for example in a data center or in battery-operated mode, the system could configure the CLP to run each thread at a high energy-efficient point. FIG. 6B shows an energy optimized CLP configuration may be capable of running eight threads across a range of processor granularities (640, 650 and 660). In this example composed processor 640 may include two processing cores, composed processor 650 may be formed with four processing cores, and composed processor 660 may be formed with eight processing cores. FIG. 6C shows an example energy optimized CLP configuration capable of running one thread on a single composed processor 680 established with all processing cores 610 (e.g., 32 processing cores in this illustrative example).

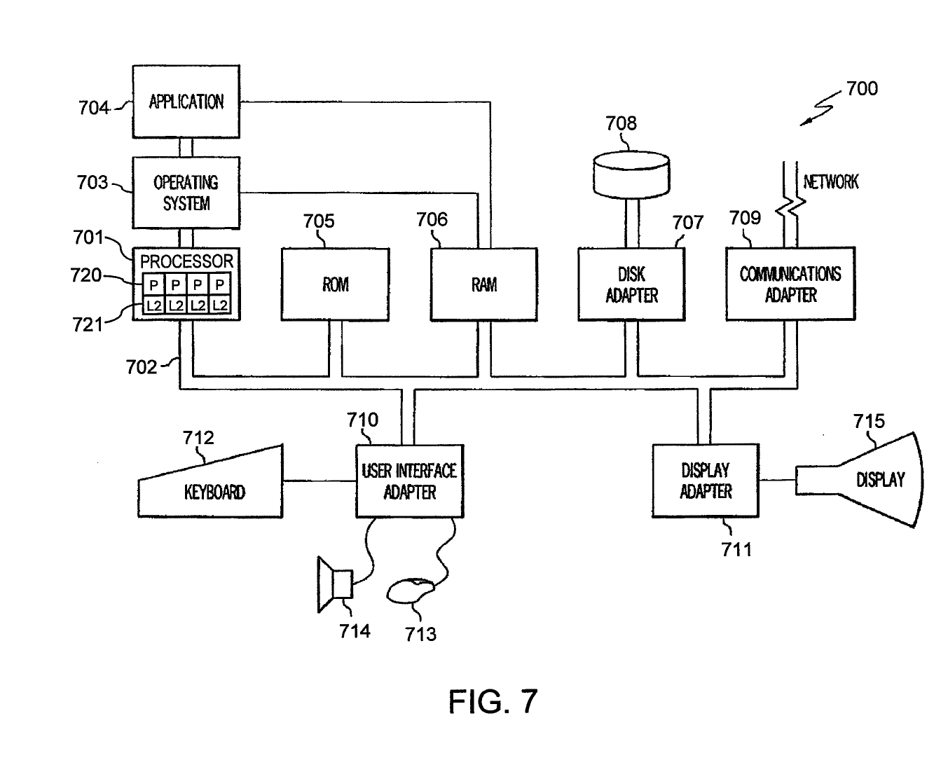

FIG. 7 is a schematic diagram of an example of a hardware configuration of a computer system configured for use with an example of a method for counting dependence predictors, arranged in accordance with the present disclosure. Computer system 700 may include one or more of a processor 701, which may include an example of counting dependence predictor (“CDP”) 724, a system bus 702, an operating system 703, an application 704, read-only memory (“ROM”) 705, random access memory (“RAM”) 706, a disk adapter 707, a disk unit 708, a communications adapter 709, a user interface adapter 710, a display adapter 711, a keyboard 712, a mouse 713, a speaker 714, a display monitor 715, processing cores 720, and/or banked L2 caches 721. The processor 701 may be coupled to the various other components by the system bus 702. Processor 701 may be a multi-core processor that may include a number of the processing cores 720 and banked L2 caches 721, which may be arranged, for example, in configurations 601-603. As will be appreciated in light of the present disclosure, the multiple processing cores 720 are interconnected and interoperable, such as by an on-chip network, such as on-chip network 305, for example. Referring to FIG. 7, an operating system 703 may run on processor 701 configured to provide control and coordinate the functions of the various components of FIG. 7. An application 704 that is arranged in accordance with the principles of the present disclosure may run in conjunction with operating system 703 and may be adapted to provide calls to operating system 703 where the calls may implement the various functions or services to be performed by application 704.

Referring to FIG. 7, read-only memory (“ROM”) 705 may be coupled to system bus 702 and may include a basic input/output system (“BIOS”) that controls certain basic functions of computer device 700. Random access memory (“RAM”) 706 and disk adapter 707 may also be coupled to system bus 702. It should be noted that software components including operating system 703 and application 704 may be loaded into RAM 706, which may be the computer system's main memory for execution. Disk adapter 707 may be an integrated drive electronics (“IDE”) adapter (e.g., Parallel Advanced Technology Attachment or “PATA”) that communicates with a disk unit 708, e.g., disk drive, or any other appropriate adapter such as a Serial Advanced Technology Attachment (“SATA”) adapter, a universal serial bus (“USB”) adapter, a Small Computer System Interface (“SCSI”), to name a few.

Computer system 700 may further include a communications adapter 709 coupled to bus 702. Communications adapter 709 may interconnect bus 702 with an outside network (not shown) thereby allowing computer system 100 to communicate with other similar devices. I/O devices may also be coupled to computer system 100 via a user interface adapter 710 and/or a display adapter 711. Keyboard 712, mouse 713 and speaker 714 may all be interconnected to bus 702 through user interface adapter 710. Data may be inputted to computer system 700 through any of these devices or other comparable input devices. A display monitor 715 may be coupled to system bus 702 by display adapter 711. In this manner, a user may be capable of interacting with the computer system 700 through keyboard 712 or mouse 713 and receiving output from computer system 700 via display 715 or speaker 714.

FIG. 8 is a schematic diagram of an example of a system for performing a method according to various implementations of counting dependence predictors, arranged in accordance with the present disclosure. Computer system 800 may include a processing arrangement 805, which may be configured to run a method 801. Method 801 may include one or more of blocks 810, 820 and/or 830. In one particular example, as shown in the schematic of FIG. 8, the computer system 800, such as computer system 700, may include the processing arrangement 805, such as processor 701, configured for performing the example method 801 according to various implementations of dependence prediction for executing a load operation in a memory system. In other examples, various operations or portions of various operations of the described methods may be performed outside of the processing arrangement 805. In various examples, the method may include associating one of a plurality of prediction types to a load operation from the memory (block 810). The method may then include evaluating whether any precedents for the associated prediction type have been satisfied (block 820). Further, the method may include executing the load operation if the precedents for the associated prediction type have been satisfied (block 830).

In various implementations of a CDP, when the number of matching stores varies among dynamic instances of a given static load, a load state may alternate between being dependent on zero or one store(s) to help more accurately predict the correct number of stores in such cases. Otherwise, the CDP predictor state may fluctuate based on repeated mispredictions and subsequent updates of the table. Similarly, a load state may alternate between being dependent on one or two (or more) stores.

To address the zero or one store(s) example cases described above, various implementations of CDP may be arranged to record some bits of the store's PC when a load violates. Thus, when the next instance of this load is predicted one-store, the CDP may be arranged to check if an older instance of the offending store is in flight, for example. If not, the load may be allowed to issue aggressively, provided it will not cause a violation with some other store. Such CDP implementations may reduce the number of cases where an independent load is predicted one-store and defaults to waiting for all older stores to complete because no store match ever occurs, for example. Such CDP implementations may require additional space to accommodate the bits of the store PC, and may also cause incorrect predictions in the typically less common case where the load's next dynamic instance may be dependent on a different static store, for example.

The one or two (or more) stores example cases described above may be addressed in a similar way to the zero or one store(s) example cases. When a matching store prompts the wakeup of a load predicted one-store, a check may be performed to see if there are any stores with the same PC in flight between the store match and the load. If so, the wakeup of the load may be deferred. These CDP implementations may approximate the aspect of store operation sets which serializes all in-flight stores belonging to a given store set and makes the load dependent on the last of these stores, for example. These CDP implementations may not require additional storage area, but may, in some cases, needlessly delay a load's execution, for example.

When a memory instruction executes, it may be sent to the appropriate core's cache bank based on its target address. Pipeline flushes due to misspeculations may also be initiated by the owner of the block causing the misspeculation. Since loads and stores to the same address should go to the same memory core, dependence violations may be detected by the load-store queue at that cache bank.

Each block owner may have the block's starting address (PC) of all in-flight blocks available. This information may allow the various CDP implementations that address the zero or one store(s) example cases and the one or two (or more) stores example cases described above to be implemented efficiently by checking whether another in-flight block has the same block PC address as the block of the store in question, for example.

Because various implementations of CDPs may use relatively little information (as compared to other types of memory dependence predictors) to make predictions—for example, CDPs may not need to follow all stores in the fetch stream—they may be particularly amenable to use in a distributed environment. To address problems of confirming correctness of speculations and knowing when all stores previous to a given load have completed, a number of additional control messages may be utilized. Distributed protocols may be designed in consideration of: few control messages, few control message types (i.e., low protocol complexity), or low latency on the critical path. Various implementations of CDP may be arranged to address these considerations or others.

With respect to the architecture that may be used to support the various implementations of CDP described above, composable processor arrangements may benefit from the use of a CDP. a fully composable processor shares no structures physically among the multiple processors. Instead, a composable lightweight processor (“CLP”) may rely on distributed micro-architectural protocols to provide the necessary fetch, execution, memory access/disambiguation, and commit capabilities. Full composability may be difficult in conventional instruction set architectures (“ISAs”), since the atomic units are individual instructions, which may require that control decisions be made too frequently to coordinate across a distributed processor. Explicit data graph execution (EDGE) architectures, conversely, may reduce the frequency of control decisions by employing block-based program execution and explicit intrablock dataflow semantics, and have been shown to map well to distributed micro-architectures. The particular CLP design utilized for the examples described herein, called TFlex, may be utilized to achieve the composable capability by mapping large, structured instruction blocks across participating cores differently depending on the number of cores that are running a single thread. It will be appreciated that TFlex represents only one of many processing arrangements that may be suitable for use with the current CDP.

The TFlex CLP micro-architecture allows the dynamic aggregation of any number of cores—up to 32 for each individual thread—to find the best configuration under different operating targets: e.g., performance, area efficiency, or energy efficiency.

The TFlex micro-architecture is a Composable Lightweight Processor (CLP) that allows simple cores, which may also be called tiles, to be aggregated together dynamically. TFlex is a fully distributed tiled architecture of 32 cores, with multiple distributed load-store banks, that supports an issue width of up to 64 and an execution window of up to 4096 instructions with up to 512 loads and stores. Since control decisions, instruction issue, and dependence prediction may all happen on different tiles, for example, a distributed protocol for handling efficient dependence prediction should be used.

The TFlex architecture uses the TRIPS Explicit Data Graph Execution (EDGE) instruction set architecture (ISA), which may encode programs as a sequence of blocks that have atomic execution semantics, meaning that control protocols for instruction fetch, completion, and commit may operate on a varying number of blocks. In some examples, the number of blocks may be any number of up to 128 instructions. In some examples, the number of blocks may be more. The TFlex micro-architecture may have no centralized micro-architectural structures. Structures across participating cores may be partitioned based on address. Each block may be assigned an owner core based on its starting address (PC). Instructions within a block may be partitioned across participating cores based on instruction IDs, and the load-store queue (LSQ) and data caches may be partitioned based on load/store data addresses, for example.

Various implementations of CDPs may be particularly well suited to distributed fetch and execute architectures having distributed memory banks, in which the comprehensive event completion knowledge needed by previous dependence predictors is relatively costly to make available globally, for example. For example, various implementations of CDPs may be adapted for use with Core Fusion by giving its steering management unit (SMU) the responsibilities of the controller core. In addition, while the block-atomic nature of the ISA used by TFlex generally may simplify at least some components of the protocol described herein as an example, this technique may be employed with other ISAs by artificially creating blocks from logical blocks in the program to simplify store completion tracking, for example.

The foregoing describes various examples of counting dependence predictors. Following are specific examples of methods and systems of counting dependence predictors. These are for illustration only and are not intended to be limiting. The present disclosure generally relates to systems and methods for counting dependence predictors in memory in a data processing device.

Provided and described herein, for example, is a dependence predictor for a memory system including a predictor storage storing a value corresponding to an initial prediction type associated with at least one load operation, and a state-machine having multiple states. The state-machine may be configured for determining whether to execute the load operation based upon the initial prediction type corresponding with at least one of the multiple states of the state machine, and a precedent corresponding to the at least one load operation for the initial prediction type corresponding with the at least one of the multiple states of the state-machine. Further, the state-machine may be configured to determine a subsequent prediction type associated with a subsequent load operation based on a result of the load operation. An initial prediction type may include a conservative prediction type, an aggressive prediction type, or an N-store prediction type. The states of the state machine may correspond to the conservative prediction type, the aggressive prediction type, and the N-store prediction type. The state machine may be configured to set the state corresponding to the conservative prediction type upon an invalid load operation resulting from an improper prediction. The N-store prediction type may include at least one of a plurality of N-store prediction types, and the state machine may be configured to change the current state of operation from the conservative prediction type state to the state associated with one of the N-store prediction types upon completing a successful load operation. The state machine may be configured for changing the current state of operation from the state associated with a first of the N-store prediction types to the state associated with a second of the N-store prediction types upon completing a successful load operation. The state machine may be configured for changing the current state of operation from the state associated with an N-store prediction type to a state associated with the aggressive prediction type upon completing a successful load operation.

A processing core may be included as well as at least one of a plurality of store operations. The processing core may be configured to send at least one control message when all of the store operations have been computed. The precedent may include at least one of the plurality of store operations. The dependence predictor may further include a processing core configured to send a message indicating whether at least one of the load operations has been held back waiting for the store operation, and/or a held back load operation is safe to execute. The dependence predictor may further include a processing core configured to send a message indicating that the store operation has been executed. The predictor storage and the state-machine may be implemented on the memory side of a distributed architecture system.

Also provided and described herein, for example, is a method of dependence prediction in executing a load operation in a memory system including associating a prediction type from a plurality of prediction types to a load operation in the memory system; evaluating whether a precedent, corresponding to the load operation for at least one of the plurality of prediction types are satisfied; and executing the load operation if the precedents for the associated prediction type have been satisfied. The precedent may include a store operation, and method may further include sending a control message if all store operations up to a set point have been computed. The method may further include sending a message indicates that either a load operation has been held back waiting for a store operation, and/or a held back load operation is safe to execute. The method may further include sending a message indicating that a store operation has been executed. The method may be performed on a processing arrangement.

In addition, provided and described herein, for example, is a computer-accessible medium having stored thereon computer executable instructions for dependence prediction in a memory system. When the executable instructions are executed by a processing arrangement, the processing arrangement may be configured to perform a procedure including associating a prediction type from a plurality of prediction types to a load operation in the memory system, evaluating whether precedents for the associated prediction type are satisfied, and executing the load operation if the precedents for the associated prediction type are satisfied. The precedent may include a store operation, and the processing arrangement may be further configured to perform a further procedure including sending a control message when all store operations up to a set point have been computed. The processing arrangement may be further configured to perform a further procedure comprising sending a message. The message may indicate that either a load operation has been held back waiting for a store operation, or a held back load operation may be safe to execute. The precedent may include the store operation. The processing arrangement may be further configured to perform a further procedure including sending a message indicating a load operation has been held back waiting for a store operation, and/or a held back load operation may be safe to execute. Further, the processing arrangement may be further configured to perform a further procedure including sending a message indicating that a store has been executed.

The foregoing detailed description has set forth various examples of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one example, several portions of the subject matter described herein may be implemented via Application Specific Integrated Circuits (“ASICs”), Field Programmable Gate Arrays (“FPGAs”), digital signal processors (“DSPs”), or other integrated formats. However, those skilled in the art will recognize that some aspects of the examples disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. For example, if a user determines that speed and accuracy are paramount, the user may opt for a mainly hardware and/or firmware vehicle; if flexibility is paramount, the user may opt for a mainly software implementation; or, yet again alternatively, the user may opt for some combination of hardware, software, and/or firmware.

In addition, those skilled in the art will appreciate that the mechanisms of the subject matter described herein are capable of being distributed as a program product in a variety of forms, and that an illustrative example of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (“CD”), a Digital Video Disk (“DVD”), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and examples have been disclosed herein, other aspects and embodiments will be apparent to those skilled in the art. The various aspects and examples disclosed herein are for purposes of illustration and are not intended to be limiting, with the true scope and spirit being indicated by the following claims.

What is claimed is:

1. A dependence predictor for a memory system, comprising:
a predictor storage arranged to store a value corresponding to an initial prediction type associated with at least one load operation; and
a state-machine operable in multiple states, the state-machine configured to:
determine whether to execute the at least one load operation based upon the initial prediction type corresponding with one of the multiple states of the state-machine, and also based upon a precedent corresponding to the at least one load operation for the initial prediction type, wherein the precedent includes N preceding store operations being completed;
determine a result of execution of the load operation; and
determine a subsequent prediction type associated with a subsequent load operation based on the result of execution of the load operation.

2. The dependence predictor of claim 1, wherein the initial prediction type corresponds to one of a conservative prediction type, an aggressive prediction type, or an N-store prediction type.

3. The dependence predictor of claim 2, wherein the at least one of the multiple states of the state machine correspond to one of the conservative prediction type, the aggressive prediction type, or the N-store prediction type.

4. The dependence predictor of claim 2, wherein:
the N-store prediction type comprises a plurality of N-store prediction types; and
the state machine is configured to change its current state of operation from the conservative prediction type state to the state associated with one of the plurality of N-store prediction types upon completing a successful load operation.

5. The dependence predictor of claim 3, wherein the state machine is configured to select a current state of operation as the state corresponding to the conservative prediction type upon an invalid load operation resulting from an improper prediction.

6. The dependence predictor of claim 5, wherein the state machine is configured to change from the current state of operation to the state associated with a first of the N-store prediction types to the state associated with a second of the N-store prediction types upon completing a successful load operation.

7. The dependence predictor of claim 5, wherein the state machine is configured to change from the current state of operation to the state associated with one of the N-store prediction types to a state associated with the aggressive prediction type upon completing a successful load operation.

8. The dependence predictor of claim 1, further comprising a processing core, wherein the precedent includes at least one of the plurality of store operations, and wherein the processing core is configured to send at least one control message indicating whether the at least one load operation should be held back waiting for prior store operations to execute.

9. The dependence predictor of claim 1, further comprising a processing core, wherein the precedent includes at least one of the plurality of store operations, and wherein the processing core is configured to send at least one control message when all of the store operations have been executed.

10. The dependence predictor of claim 9, wherein the at least one control message further indicates that a load operation has been held back waiting for some number of prior store operations to execute.

11. The dependence predictor of claim 1, wherein the predictor storage and the state-machine are implemented on a memory side of a distributed architecture system.

12. The dependence predictor of claim 1, wherein the predictor storage and the state-machine are implemented on an execution side of a distributed architecture system.

13. A method of dependence prediction for executing a load operation in a memory system, comprising:
associating a prediction type from a plurality of prediction types to a load operation in the memory system;
evaluating whether a precedent, corresponding to the load operation for at least one of the plurality of prediction types, has been satisfied, wherein the precedent includes N preceding store operations being completed; and
executing the load operation if the precedents for the associated prediction type are satisfied.

14. The method of claim 13, further comprising sending a control message if all store operations up to a set point have been executed, wherein the precedents include the store operations.

15. The method of claim 13, further comprising sending a message, wherein the message indicates that either a load operation has been held back waiting for a store operation, or a held back load operation is safe to execute, wherein the precedent includes the store operation.

16. The method of claim 13, further comprising sending a message indicating that a store operation has been executed, wherein the precedent includes the store operation.

17. A computer-accessible medium having stored thereon computer executable instructions for dependence prediction in a memory system, wherein, when the executable instruction are executed by a processing arrangement, the processing arrangement being configured to perform a procedure comprising:
associating a prediction type from a plurality of prediction types to a load operation in the memory system;
evaluating whether precedents for the associated prediction type are satisfied, wherein the precedents include N preceding store operations being completed; and
executing the load operation if the precedents for the associated prediction type are satisfied.

18. The computer-accessible medium of claim 17, the processing arrangement being further configured to perform a further procedure comprising sending a control message when all store operations up to a set point have been executed, wherein the precedents include the store operations.

19. The computer-accessible medium of claim 17, the processing arrangement being further configured to perform a further procedure comprising sending a message, wherein the message indicates that either a load operation has been held back waiting for a store operation, or a held back load operation is safe to execute, wherein the precedent includes the store operation.

20. The computer-accessible medium of claim 17, the processing arrangement being further configured to perform a further procedure comprising sending a message indicating that a store operation has been executed, wherein he precedent includes the store operation.
